(19) United States
(12) Patent Application Publication
(10) Pub. No.: US 2006/0112435 A1
(43) Pub. Date: May 25, 2006

(54) Method and system for assembling and delivering digital actor portfolios to casting personnel

(75) Inventor: Susan Jean Fox, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Casting Workbook Services Inc., Vancouver (CA)

(21) Appl. No.: 11/200,113

(22) Filed: Aug. 10, 2005

Related U.S. Application Data
(60) Provisional application No. 60/599,885, filed on Aug. 10, 2004.

(51) Int. Cl. G06F 17/30

(52) U.S. Cl. 726/31

(57) ABSTRACT

The invention provides a method of delivering a compilation of physical materials reproduced from digital files by communicating a selection of materials and recipients to a packager in the same urban location as the recipient, physically reproducing the files, forming a physical package and delivering it to the recipient.

### CROSS-REFERENCE TO RELATED APPLICATION

This application claims priority from U.S. provisional application No. 60/599,885 filed Aug. 10, 2004, which is pending.

### TECHNICAL FIELD

The invention relates to the process of taking digitized media from a digital library, and ordering a physical package to be created and delivered to a specific person within a specific timeframe in a specified city.

### BACKGROUND ART

Traditionally, Entertainment Professionals such as Casting Director and Agents would make copies of audition tapes, photocopy resumes and order multiple copies of headshots. With the advances in internet technology many Agents are now storing their headshots on computers, plus with digital cameras becoming more reasonably priced, more and more auditions are being digitized and stored in online libraries such as Casting Workbook™.

When a request from a distant city comes in to the Agent for an Actor's or Model's Headshot, Resume and/or Demo Reel or Taped Audition (Audio or Video), the Agent presently has to pay to have copies made of digitized media (Audio or Video), copies made of resumes and headshots. They would then have to use traditional methods of getting the materials to the Requestor. If the Requestor was local, then a courier, if the Requestor was far away, then an international courier such as Federal Express or UPS is used.

By using traditional shipping methods, the materials would generally arrive the next business day if the Requestor was not local. This method is costly and time consuming for both the Agent and Actor. Furthermore, Agents who prefer to work online using services such as Casting Workbook to store their digital materials, have to rely on staff and other methods of assembling the materials to be sent to the Requestor.

### DISCLOSURE OF INVENTION

The present invention provides a method of delivering digitized materials in a traditional manner that is cost effective and timely, in addition to being a part of a workflow that incorporates modern technologies such as the Internet.

More particularly the invention provides method of creating and delivering from a sender in a first location to one or more selected recipients in a second location a customized physical compilation of materials reproduced from one or more digital files, comprising: i) storing the one or more digital files in the memory of a searchable database; ii) providing a web site accessible over the Internet; iii) displaying to a sender who has accessed the web site a plurality of selections for including in customized physical compilation of materials; iv) the sender selecting the one or more digital files and the one or more selected recipients; v) send sender communicating the selections of the sender over the Internet to a packager in a location more accessible by physical delivery to the second location than the first location; vi) the packager making physical reproductions of the one or more digital files, forming the customized physical compilation of materials from the reproductions and delivering the customized physical compilation of materials to the one or more selected recipients. The digital files may be text files, audio files, video files, digital photographs or any combination thereof. The invention also provides computer software for carrying out the method.

### BRIEF DESCRIPTION OF DRAWINGS

In drawings which disclose a preferred embodiment of the inventions,

FIG. 1 is a Flowchart illustrating the flow of the system.

FIG. 2-6 are images of computer screen displays as used in the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

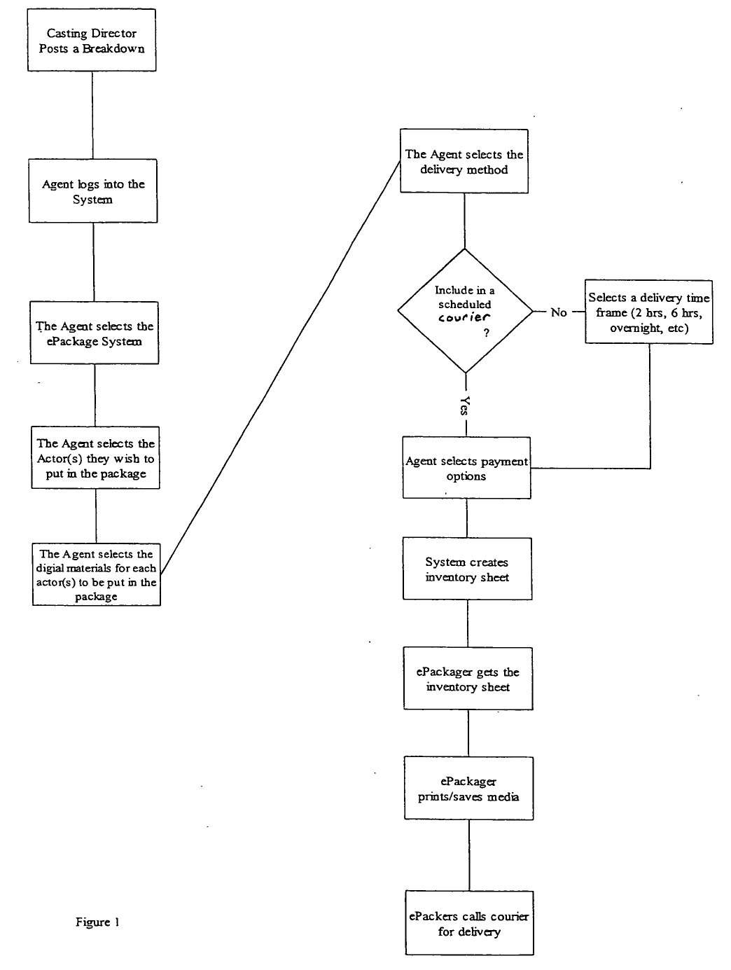

With reference to FIG. 1, a Requestor, typically a Casting Director will send out a Breakdown or a request to the industry for Actor materials. Unless the Casting Director is already in the habit of using online technologies to manager their auditions, the Casting Director would typically ask that the materials be sent to their office. The Sender, typically an Agent will access the portal web site (e.g. Casting Workbook). They would then go to the delivery application according to the invention (referred to herein by the trademark ePackage™). They would select to whom the ePackage would be sent (e.g. Requestor). The Sender would then create a coversheet to go with the package, complete with their logo, and enter metadata such as project, role, etc as a reference to the ePackager™. The ePackager is someone in the same destination city as the Requestor, who will gather the materials and ensure the Requestor receives the ePackage. The Sender will then select the materials from their online libraries. If the Sender was an Agent they would select from their Online Roster, and then select materials from each individual Model or Actor's online library. If the Sender, was a Producer they would just select materials from their online library.

The Sender would then select the best method of delivery. If there is a group of ePackages currently scheduled to go to the Requestor, the Sender can opt to include their ePackage in the group, thereby saving money, or the Sender can select to have the package sent within a particular time interval within standard business hours. (e.g. 2 hours, 4 hours, 6 hours, 8 hours or overnight). The Sender would then select a payment option. Either electing to pay online, invoice or other options the portal elects to use for this invention.

Once the Sender's payment is approved, the System will provide the Sender with a receipt, and estimated time of delivery. The System will also notify the ePackager there is a package that needs to be created. The ePackager will ask the system to provide him with an inventory list and create an Online Print Package of cover letters, headshots and resumes that the ePackager can send to the printer. The ePackager will also have the option on how to sort the materials in the package, either by Actor or Role. If the ePackager chooses to sort by Role, then the Actors will be ordered in the online print package by role alphabetically. If the ePackager chooses to sort by Actor, then the Actors in the online print package will be ordered alphabetically.

The System will also present a list of the digital media the ePackager will download and burn to a DVD and/or CD depending on the media type and the request of the Requestor. VHS is also an option that may be available.

The ePackage is assembled it will be bound by Agency and then a local courier will be used to get the materials to the Requestor, either by the deadline of the breakdown or by the delivery option selected by the Sender. The ePackager will note the time the ePackage leaves their location as well as when the ePackage arrives, as they are notified by the courier. The Sender can view reports of when a package leaves and arrives at the Requestor's location, and if possible any other information such as Courier service used, who signed for it, etc.

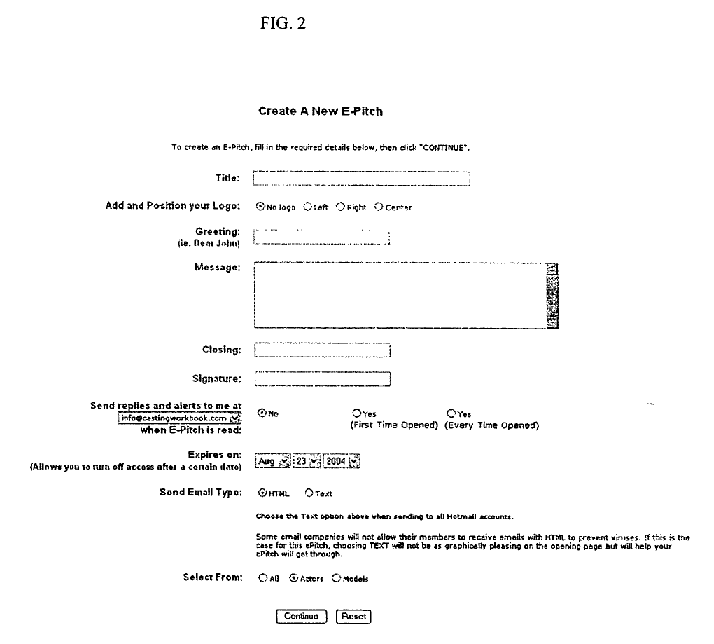

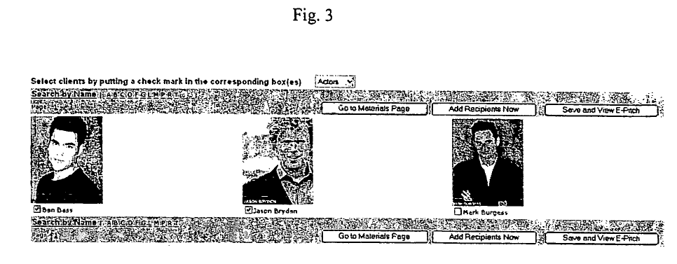

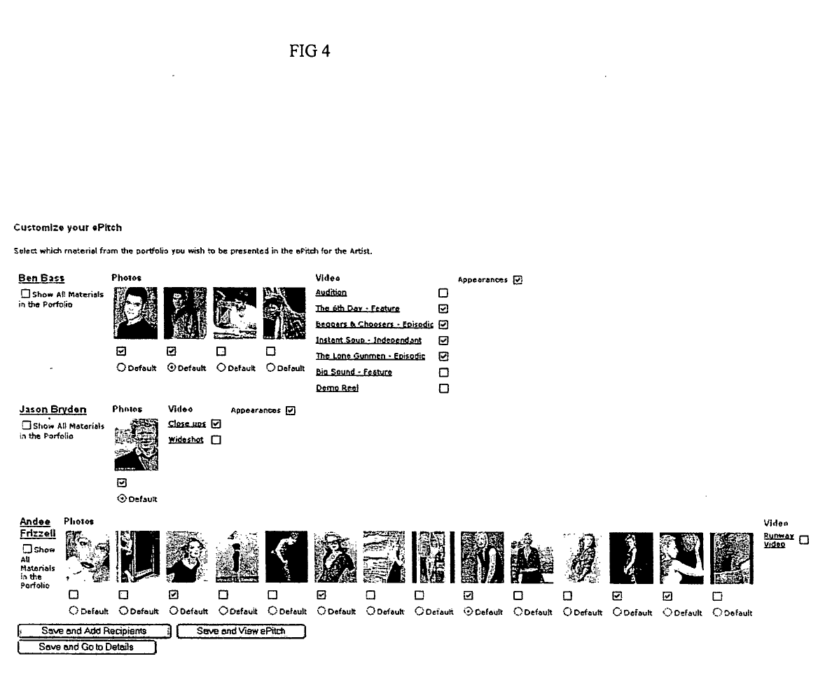

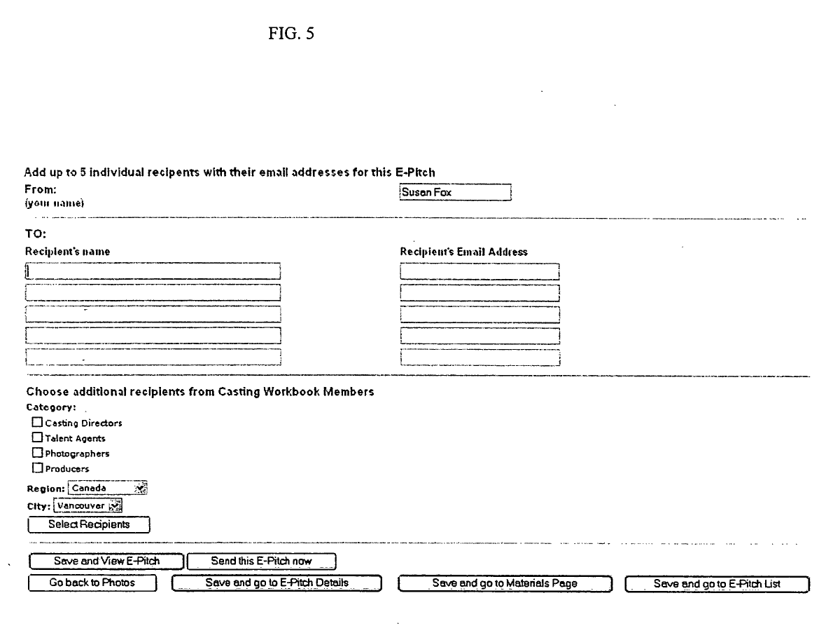

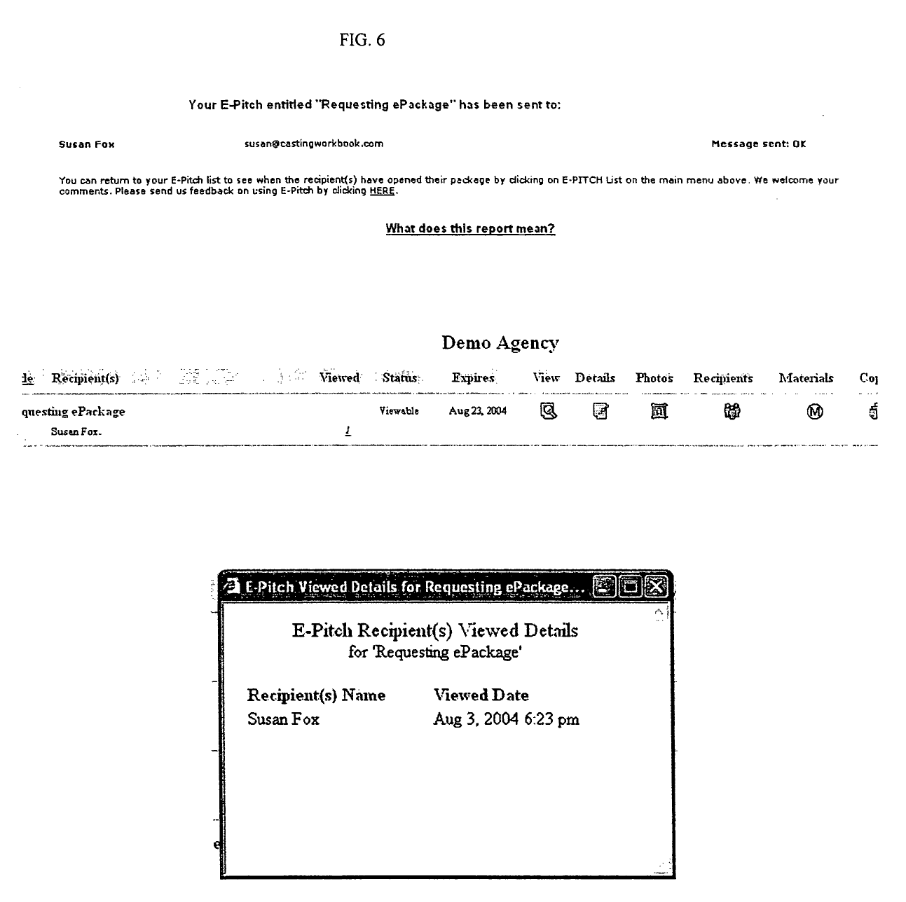

With reference to FIGS. 2-6, which show screen displays used in the method of the invention, FIG. 2 illustrates the screen used in the first step to create a cover letter that can be emailed as well as printed and included with the hard copy in the chosen destination city. As shown in FIG. 3, next the actor portfolio(s) to be sent are chosen. In the case of an actor or producer, this is automatically selected. Portfolios can be chosen alphabetically or by a search. As shown in FIG. 4, next, the individual photos, documents, audio and/or video clips are selected for sending from each portfolio. As shown in FIG. 5, next, the recipients are added for email distribution. This can be manually typed as well as selected from a group by category or city. This email as an ePackage may be sent to one or more designated cities for output and distribution. It may include an eCommerce capability that will predetermine the price prior to proceeding. With reference to FIG. 6, once the user selects SEND a confirmation page shows that the ePackage™ was sent successfully or failed. After sending, the user can go to a reports/list page to view whether the email has been received and opened. A confirmation of the courier sent from the various cities may appear here. Clicking on the number under “viewed” allows the user to see that their ePackage request was received and at what time.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of creating and delivering from a sender in a first location to one or more selected recipients in a second location a customized physical compilation of materials reproduced from one or more digital files, comprising:
i) storing said one or more digital files in the memory of a searchable database;
ii) providing a web site accessible over the Internet;
iii) displaying to a sender who has accessed said web site a plurality of selections for including in customized physical compilation of materials;
iv) said sender selecting said one or more digital files and said one or more selected recipients;
v) send sender communicating said selections of said sender over the Internet to a packager in a location more accessible by physical delivery to said second location than said first location;
vi) said packager making physical reproductions of said one or more digital files, forming said customized physical compilation of materials from said reproductions and delivering said customized physical compilation of materials to said one or more selected recipients.

2. The method of claim 1 wherein said one or more digital files are selected from the group text files, audio files, video files and digital photographs.

3. The method of claim 1 wherein said sender is a talent agent, said customized physical compilation of materials is a portfolio for a talented individual and said one or more selected recipients are the target of a pitch by an agent for said talented individual.

4. The method of claim 3 further comprising the step of said sender creating an electronic cover letter for said customized physical compilation of materials.

5. The method of claim 1 wherein said packager notifies said sender electronically of the times for delivery and receipt by said one or more recipients of said customized physical compilation of materials.

6. The method of claim 1 wherein said second location is an urban center and said packager is located in said urban center.

7. The method of claim 1 wherein step of selecting said one or more digital files is done automatically.

8. The method of claim 1 wherein said sender can view a report on said web site of the receipt by said one or more recipients of said customized physical compilation of materials.

9. A computer program product for creating and delivering from a sender in a first location to one or more selected recipients in a second location a customized physical compilation of materials reproduced from one or more digital files, comprising:
a computer usable medium having computer readable program code means embodied in said medium for:
i) storing said one or more digital files in the memory of a searchable database;
ii) providing a web site accessible over the Internet;
iii) displaying to a sender who has accessed said web site a plurality of selections for including in customized physical compilation of materials;
iv) permitting said sender to select said one or more digital files and said one or more selected recipients;
v) permitting said send sender to communicate said selections of said sender over the Internet to a packager in a location more accessible by physical delivery to said second location than said first location;
vi) permiting said packager to make physical reproductions of said one or more digital files for forming said customized physical compilation of materials from said reproductions and delivering said customized physical compilation of materials to said one or more selected recipients.

10. The computer program product of claim 9 wherein said one or more digital files are selected from the group text files, audio files, video files and digital photographs.

11. The computer program product of claim 9 wherein said sender is a talent agent, said customized physical compilation of materials is a portfolio for a talented individual and said one or more selected recipients are the target of a pitch by an agent for said talented individual.

12. The computer program product of claim 9 further comprising the step of said sender creating an electronic cover letter for said customized physical compilation of materials.

13. The method of claim 1 wherein step of selecting said one or more digital files is done automatically.

14. The computer program product of claim 9 wherein said sender can view a report on said web site of the receipt by said one or more recipients of said customized physical compilation of materials.

15. The computer program product of claim 9 wherein said user is able to save said email and select to send a previously saved email.
